(19) United States
(12) Patent Application Publication
(10) Pub. No.: US 2023/0376744 A1
(43) Pub. Date: Nov. 23, 2023

(54) DATA STRUCTURE CORRECTION USING NEURAL NETWORK MODEL

(71) Applicant: Microsoft Technology Licensing, LLC, Redmond, WA (US)

(72) Inventors: Tiancong ZHOU, Kenmore, WA (US); Ke WANG, Redmond, WA (US); Ahmed MOHAMED, Bellevue, WA (US)

(73) Assignee: Microsoft Technology Licensing, LLC, Redmond, WA (US)

(21) Appl. No.: 17/749,772

(22) Filed: May 20, 2022

(51) Int. Cl. G06N 3/08; G06F 16/23

(52) U.S. Cl. CPC G06N 3/08; G06F 16/2365

(57) ABSTRACT

A method for data structure modification is described. First data structures that represent user interactions with first user content by a user of a client device are obtained. The first data structures are labeled using content features of the first user content. A neural network model is trained using the labeled first data structures to obtain user-specific weights for the user of the client device. A second data structure that represents user interactions with second user content by the user is received. A predicted value for the second data structure is obtained based on an output of the trained neural network model using content features of the second user content and the user-specific weights as inputs to the trained neural network model. The second data structure is modified to include the predicted value when the second data structure is inconsistent with the predicted value.

### BACKGROUND

Enterprise organizations may manage large amounts of data for entities associated with the organization, such as various users (e.g., employees), emails sent and read by the users, documents generated and viewed by the users, meetings attended by the users, etc. These entities may have relationships among themselves, for example, a first user (e.g., a first entity) may have an authorship relationship with a document that they generated (e.g., a second entity). Further relationships may be created or modified when the document is shared with a second user of the organization, included in an email message, or referenced within a meeting invite. Knowledge of these relationships may be leveraged to recommend relevant entities to a user when performing some tasks, such as reading an email or group of emails (e.g., an estimate of how long a user will spend checking new messages), sending an email (e.g., recommendations for documents to be attached) or composing a meeting invite (e.g., recommendations for users to invite). Moreover, the relationships may provide insights into how applications or documents are used, by whom, etc.

To manage the knowledge of these relationships, signals may be generated that represent the interactions (e.g., who has created, accessed, copied, modified, and/or saved a document), where the signals are suitable data structures. Different types of signals may be generated according to an action, such as a document creation signal, a document open signal, a meeting request signal, etc. The signals may be transmitted to a signal data store (e.g., disk drive or other memory), but some scenarios may result in signals that are incomplete and/or inaccurate. For example, when a user scrolls through unread email messages and highlights a new email to be read but then is interrupted by a phone call or a lunch break, the new message may be highlighted for a longer duration than the user needed to actually read the new email. In this example, a ViewMessage signal may indicate that a duration of reading the new email was 75 minutes (e.g., while the user was at lunch), when the user actually only spent two minutes reading the new email. In these scenarios, the signal may inaccurately reflect the behavior of the user when reading the new email, which reduces data integrity of the signal data store.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure are directed to signal verification.

In one aspect, a method for data structure modification is provided. The method includes: obtaining first data structures that represent user interactions with first user content by a user of a client device; labeling the first data structures using content features of the first user content; training a neural network model using the labeled first data structures to obtain user-specific weights for the user of the client device; receiving a second data structure that represents user interactions with second user content by the user; obtaining a predicted value for the second data structure based on an output of the trained neural network model using content features of the second user content and the user-specific weights as inputs to the trained neural network model; and modifying the second data structure to include the predicted value when the second data structure is inconsistent with the predicted value.

In another aspect, a method for data structure modification is provided. The method includes: processing a telemetry log representing first user interactions with first user content by a user of a client device to identify the first user interactions; generating a predicted data structure that corresponds to the identified first user interactions based on an output of a trained neural network model using content features of the first user content and user-specific weights as inputs to the trained neural network model, including mapping entries within the telemetry log to fields within the predicted data structure, and populating the fields within the predicted data structure with data based on the mapped entries within the telemetry log; identifying discrepancies between the predicted data structure and first data structures that were previously generated based on second user interactions of the user of the client device, wherein the second user interactions include the first user interactions; and updating the first data structures based on the identified discrepancies.

In yet another aspect, a system for processing data structures that represent user interactions is provided. The system includes a signal processor configured to process received data structures. The signal processor is configured to: obtain first data structures that represent user interactions with first user content by a user of a client device; label the first data structures using content features of the first user content; train a neural network model using the labeled first data structures to obtain user-specific weights for the user of the client device; receive a second data structure that represents user interactions with second user content by the user; obtain a predicted value for the second data structure based on an output of the trained neural network model using content features of the second user content and the user-specific weights as inputs to the trained neural network model; and modify the second data structure to include the predicted value when the second data structure is inconsistent with the predicted value.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 shows a block diagram of an example of a signal processing system, according to an example embodiment.

FIG. 2 shows a diagram of an example data structure for the signal processing system of FIG. 1, according to an embodiment.

FIG. 3 shows a block diagram of an example of a message flow for signal processing, according to an example embodiment.

FIG. 4 shows a block diagram of an example of a message flow for signal processing, according to an example embodiment.

FIG. 5 shows a flowchart of an example method for data structure modification, according to an example embodiment.

FIG. 6 shows a flowchart of an example method for data structure modification, according to an example embodiment.

FIG. 7 is a block diagram illustrating example physical components of a computing device with which aspects of the disclosure may be practiced.

FIGS. 8 and 9 are simplified block diagrams of a mobile computing device with which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Metadata about application and/or document interactions among users in a large organization may be captured by generating signals that represent the interactions, but accurate processing of the signals may be challenging. Generally, the applications may be used to interact with documents, files, emails, instant messages or chats, streaming audio or video, contacts, calendars or calendar items (e.g., meeting requests, reminders, appointments), or other suitable data. Signals may be generated to indicate which users have created, accessed, copied, modified, and/or saved a document, for example, or to indicate how software applications are used, which features, patterns of use, etc. Generally, a signal is a data structure for a high-value event that represents a user behavior or interaction. Knowledge of the behavior or interaction allows for analysis to power rich and intelligent user-facing features, for example, predicting how long a user will need to read and/or reply to an individual email message or even a group of unread email messages, suggesting relevant invitees to a user when scheduling a meeting, or suggesting documents to be uploaded to a website. A signal can be either active (like joining a meeting or reading an email) or passive (like a location change).

As discussed above, some scenarios may result in signals that are incomplete and/or inaccurate. For example, when a user scrolls through unread email messages and highlights a new email to be read but then is interrupted by a phone call or a lunch break, the new message may be highlighted for a longer duration than the user needed to actually read the new email. As another example, a user may accidentally click to open a document causing it to be marked as “viewed” and then the user may immediately click to close the document, resulting in a very short duration of viewing the document. In these scenarios, the signal may inaccurately reflect the behavior and/or interactions of the user (e.g., when reading a document or email), which reduces data integrity of the signal data store. If the signals are of poor quality, then analytics based on the signals are not accurate and related user experiences based on the signals have reduced quality. To improve the accuracy of the signals, examples of a signal processing system described herein use a neural network model to cross-verify signals, for example, by predicting values of fields within signals. The neural network model is trained using existing, stored signals which may be specific to a particular user. Moreover, the neural network model may be trained using features from content with which the user has interacted. For example, signals may be generated that represent when a user has read an email message and features from that email message (e.g., an identity of a sender, a subject line, etc.) may be used to label the signals for training. When predicted values of fields are different from the stored signal, the signal processing system may modify the signals or even create new signals that may have been omitted.

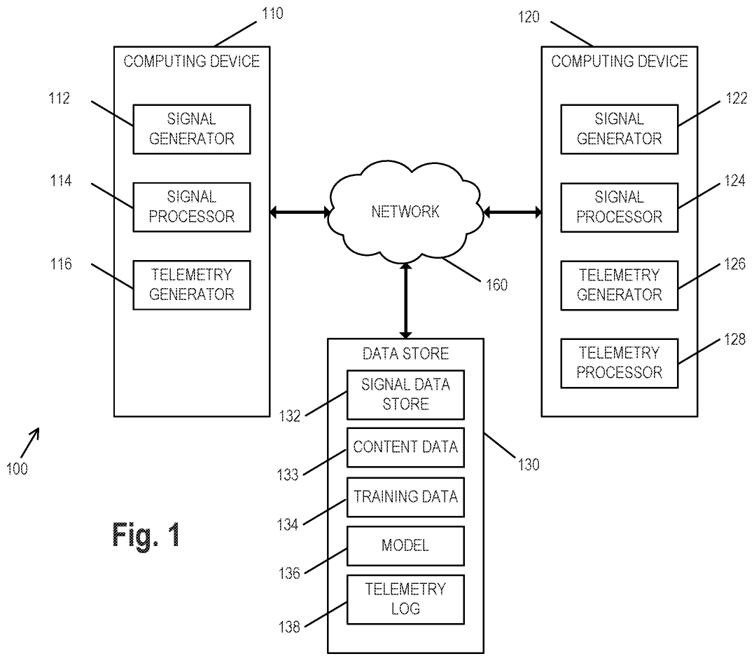

This and many further embodiments for a computing device are described herein. For instance, FIG. 1 shows a block diagram of an example of a signal processing system 100, according to an example embodiment. The signal processing system 100 includes a data store 130 and one or more computing devices, such as computing device 110 and computing device 120. A network 160 communicatively couples computing device 110, the computing device 120, and the data store 130. The network 160 may comprise one or more networks such as local area networks (LANs), wide area networks (WANs), enterprise networks, the Internet, etc., and may include one or more of wired, wireless, and/or optical portions.

Computing device 110 may be any type of computing device, including a mobile computer or mobile computing device (e.g., a Microsoft® Surface® device, a laptop computer, a notebook computer, a tablet computer such as an Apple iPad™, a netbook, etc.), or a stationary computing device such as a desktop computer or PC (personal computer). Computing device 110 may be configured to execute one or more software applications (or “applications”) and/or services and/or manage hardware resources (e.g., processors, memory, etc.), which may be utilized by users of the computing device 110. The computing device 110 may include one or more of a signal generator 112, a signal processor 114, and a telemetry generator 116, described below. Users of the computing device 110 may utilize the computing device 110 to access documents, send and receive email messages or meeting requests, send and receive instant messages or chat messages, open documents or other files, and other suitable tasks.

The computing device 120 may include one or more server devices, distributed computing platforms, cloud platform devices, and/or other computing devices. Generally, the computing device 120 is similar to the computing device 110 and may be implemented as a mobile computer, tablet computer, etc. In some examples, the computing device 120 is a network server, cloud computing device, distributed processing device, or other suitable computing device. The computing device 120 may include one or more of a signal generator 122, a signal processor 124, and a telemetry generator 126, which are generally similar to the signal generator 112, the signal processor 114, and the telemetry generator 116, respectively. The computing device 120 may further include a telemetry processor 128.

The signal generators 112 and 122 are configured to generate and send signals to the data store 130. As described above, signals generally capture data about how applications and/or documents are used (or not used). In other words, the signals are metadata of user interaction with applications and/or documents and may identify users that have created, accessed, copied, modified, and/or saved a document. The signal generators 112 and 122 may be implemented as a module within a software application (e.g., a module within a word processor for a text document), an operating system component (e.g., a file explorer application or resource monitor), a network processor that examines network packets, or other suitable processors or modules. In some examples, one or more of the signal generators 112 and/or 122 are implemented as back-end modules for a software service, a log file processing routine, a database routine, or other suitable implementation.

The signal processors 114 and 124 are configured to process the signals before and/or after storage. In various examples, the signal processors 114 and 124 are configured to process, aggregate, and/or extract data from signals (e.g., received and/or stored in a signal store). As one example, the signal processor 114 is configured to determine an estimated reading duration for one or more emails. For example, the signal processor 114 may determine that twenty unread email messages are likely to take a user fifteen minutes to read. The signal processor 114 may be configured to provide a user interface notification (e.g., a pop-up window) that indicates the estimated reading duration and prompts the user to confirm whether to create a calendar item that blocks out time for the user to read the emails using the estimated reading duration.

The telemetry generators 116 and 126 are configured to generate data for a telemetry log (e.g., telemetry log 138) that represents user interactions with a client device (e.g., with documents, user interface elements such as buttons and widgets, etc.). As a user interacts with a user interface of the client device (e.g., computing device 110 or computing device 120), the telemetry generators 116 and 126 monitor for key presses, button presses, scrolling, triggers, events, or other suitable indications of interactions with the client device, along with applications that were started, interacted with, closed, and documents read and/or modified, etc. and provide a corresponding record in the telemetry log 138. An example entry in the telemetry log 138 includes a timestamp, a user identifier for the interaction (e.g., a user name or unique user ID), an action type identifier (e.g., saving a document, opening a new document, changing between foreground and background windows, etc.), or other suitable information. In some scenarios, signals generated by the signal generators 112 and 122 contain information that is duplicated or similar to information within the telemetry log 138. In some examples, the telemetry processor 128 is configured to process the telemetry log 138 to create and/or modify signals, such as signals that have incorrect values in fields, missing values from fields, or even missing signals. In this way, the telemetry processor 128 improves reliability of stored signals, allowing for more accurate and useful predictions based on the signals.

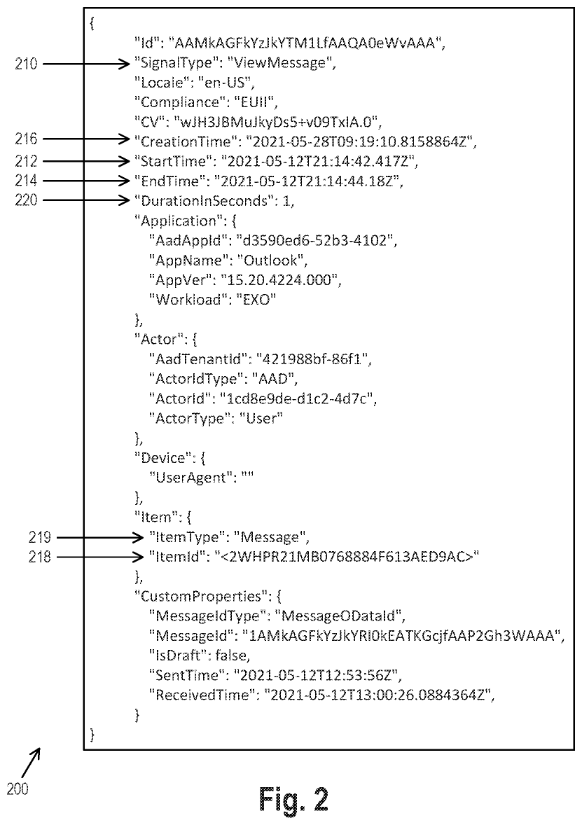

FIG. 2 shows a diagram of an example data structure 200 for the signal processing system of FIG. 1, according to an embodiment. In some examples, a signal is a data structure 200 represented as a plain text file or data portion, for example, using XML or another suitable language. An example data structure 200 may include various fields for metadata, such as a SignalType field 210 that indicates a type of action that was taken by a user (e.g., open file, copy file, call a second user, view a message), a StartTime field 212 that indicates when the action was started, an EndTime field 214 that indicates when the action was stopped (e.g., how long did a file take to open, a duration of a phone call, a duration of time spent reading an email), a CreationTime field 216 that indicates when the signal was created, an ItemID field 218 that provides a link to content related to the signal (e.g., a link to a file that was opened, or a message that was viewed), an ItemType field 219 that indicates a type of the content related to the signal (e.g., a message type, document type, contact type), further details about an application used for the action, an actor (e.g., the user) that initiated the action, or a device the actor used for the action (e.g., the computing device 110), or other suitable information. In the example shown in FIG. 2, the data structure 200 include a Duration field 220 that indicates a time interval between the StartTime and EndTime. In other examples, the signal may be implemented as a different data structure, such as a vector, string, binary object, or other suitable data structure.

The signal generator 112 may send signals to the data store 130. In some examples, the signal generator 112 is configured to “fire and forget” the signals. In other words, the signal generator 112 does not wait for a confirmation of receipt by the data store 130. In other examples, the signal generator 112 waits for a confirmation receipt from the data store 130 and may re-send the signal (or send a new signal, not shown) if the confirmation receipt is not received.

In some examples, the signals are different from a document or document request (e.g., a request for content). For example, a user of the computing device 110 may request a text document to be opened by interacting with a file explorer window (e.g., double-clicking an icon associated with the text document) or using an “open document” dialog box and the computing device 110 may send an open document request to a document store (content data store, cloud storage service, etc., not shown) that stores the text document. The signal generator 112 may also generate and send an open signal to the data store 130. In this example, the open signal is different from the open document request and sent to a different receiver (i.e., the document store for the open document request and the data store 130 for the signal).

The data store 130 is configured to store data for the signal processing system 100 and may be implemented as a network server, cloud storage server, database, or other suitable data storage system. In some examples, the data store 130 is the Microsoft Azure Data Lake Store (ADLS). The data store 130 includes one or more of a signal data store 132, a content data store 133, a training data store 134, a neural network model 136, and the telemetry log 138, in various examples. The signal data store 132 is configured to receive and store signals from the computing device 110 and/or the computing device 120. In some examples, the data store 130 also includes a processor (not shown) that processes the signals before and/or after storage (e.g., similar to the signal processor 114). The signal data store 132 may be implemented as a plurality of shards where signals are stored in an appropriate shard of the plurality of shards. The plurality of shards represent a portion of a data or file storage system. In some examples, shards within the plurality of shards are implemented as a database, cluster, storage drives (e.g., solid state disks or hard disk drives), or other suitable memory. The plurality of shards may be distributed across multiple instances of the data store 130. In some examples, an instance of the data store 130 is designated for use with a particular set of users, such as users that work for a same company, users that live in a geographic area (e.g., Europe or North America), or users whose data is subject to a same data storage regulation (e.g., GDPR).

Signals within the signal data store 132 may be utilized to generate training data within the training data store 134. The signal processors 114 and 124 or another suitable processor may be configured to generate the training data for training the neural network model 136. After training, the neural network model 136 may be used to provide an output for modifying signals and improving reliability of the signals of the signal data store 132, as described below. In some examples, the signal processor 114 generates the training data by labeling signals using content features, as described below. The content data store 133 stores content such as emails, documents, messages, files, contacts or users, calendar items, etc. and may further include metadata for the content, in various examples. Content features of an email may include an identifier for a sender (e.g., author), an identifier for a recipient, a subject of the email, a body of the email (e.g., keywords, phrases, sentences, paragraphs, images), attachments to the email, timestamps of when the email was viewed or sent, or other suitable content features. Content features of a document may include an identifier of an author, an identifier of a user who most recently viewed the document, an identifier of a user who most recently modified the document, an identifier of a location at which the document is stored, timestamps for when the document was created/viewed/modified, attributes of the document (e.g., read-only, document type, size), or other suitable content features. Other content features, including metadata for the first user content, will be apparent to those skilled in the art.

The neural network model 136 is configured to be trained using the training data store 134 to provide an output based on a signal that verifies integrity of the signal. In some examples, the neural network model 136 is configured to use different weights or parameters for different input signals. In one example, the weights are user-specific weights. In other words, the neural network model 136 is trained using training data that is specific to a particular user and weights are determined for that particular user. This allows for predictions using the neural network model 136 to be tailored to a particular user to improve accuracy and reliability. The neural network model 136 is a regression model, such as Light Gradient Boosting Machine (LightGBM), in some examples. The user-specific weights may be stored as a vector, string, array, hash value, or other suitable data structure within the signal data store 132, the content data store 133, or another suitable data store (not shown).

The training data within the training data store 134 may be generated using tens, hundreds, or any suitable number of labels to improve the weights for a user and simplify generation of predicted values. Although a high number of labels would normally introduce a high level of complexity and cost in developer time, some of this cost is avoided using the neural network model 136 because a programmer does not need to manually identify content features that influence fields within the signals and create a software routine that explicitly refers to the identified content features. The neural network model 136 may also identify non-obvious or counter-intuitive behavior of a user. For example, when a high priority individual sends a lengthy email message to a user, a relatively longer Duration of a ViewMessage signal might be expected as the user carefully reads the message, but when the high priority individual sends the lengthy email message to a distribution list that includes the user every Friday afternoon, the user may typically skim the message, resulting in a relatively shorter Duration of the ViewMessage signal.

Although the data store 130 and its components are shown separately from the computing device 110 and computing device 120, the data store 130 may be integral with either of the computing devices 110 and 120, in other examples. In some examples, components shown within the data store 130 (e.g., signal data store 132, the training data store 134, the neural network model 136, and/or the telemetry log 138) are integral with one or more of the computing devices 110 and 120. In still other examples, the components shown within the data store 130 are separate, independent components.

In some examples, the signal generator 112, the signal generator 122, the signal processor 114, and the signal processor 124 are part of a substrate signal service that manages signals for an enterprise network configuration (e.g., with computing devices 110 and 120 and data store 130 as members).

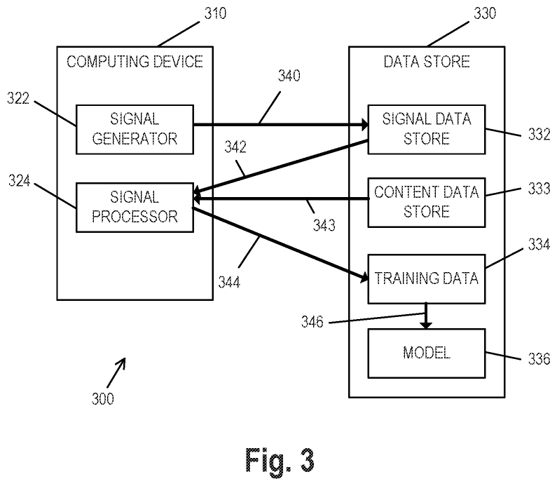

FIG. 3 shows a block diagram of an example of a message flow 300 for signal processing, according to an example embodiment. The message flow 300 begins with a computing device 310, which may generally correspond to the computing device 110 or computing device 120. The computing device 310 generates and sends a signal 340 to a signal data store 332, which may generally correspond to the signal data store 132. A signal processor 324 obtains first data structures (e.g., signals) that represent user interactions with first user content by a user of a client device.

The signal processor 324 labels the first data structures using content features 343 from a content data store 333 to generate training data 344. The signal processor 324, content data store 333, and training data 334 generally correspond to the signal processor 124, the content data store 133, and the training data store 134, for example. In some examples, the first data structure is a signal having a particular type, such as a ViewMessage signal, and the label is an identifier of a sender of an email message that caused the ViewMessage signal to be created. In one such example, labeling of the first data structure (ViewMessage signal) with the identifier of the sender allows for training a neural network model to learn suitable values for a Duration field for the first data structure when subsequent emails from that sender are received. Accordingly, when a value of a Duration field 220 is found to be unsuitable (e.g., when a discrepancy threshold is met, described below), the neural network model 336 may provide a predicted value that is more consistent with email messages from the sender.

The signal processor 324 provides the training data 344 (or a portion thereof) as inputs 346 to the neural network model 336. The neural network model 336 may correspond to the neural network model 136. As described above, training of the neural network model 336 provides user-specific weights for individual users. Although training of the neural network model 336 may be performed in an “offline” manner, the user-specific weights may be applied to an online neural network model. For example, when a new email message arrives for a user and a corresponding signal is generated (e.g., by signal generator 112), content features from the email message (e.g., an identification of a sender, a subject, length, etc.) and the user-specific weights for the user are provided to the online neural network model, which then provides an output for verification of the generated signal, described below.

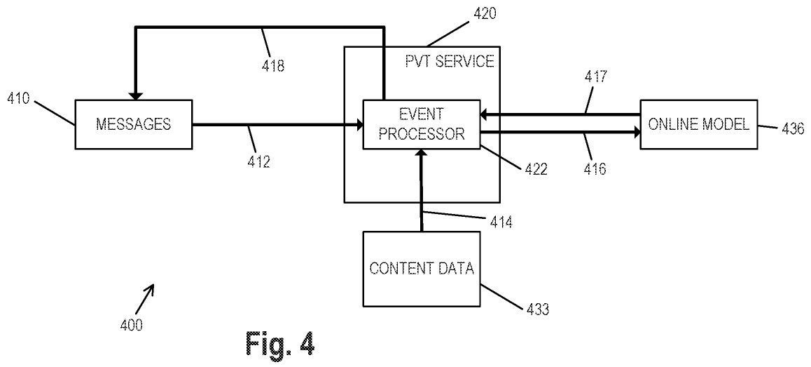

FIG. 4 shows a diagram of an example of a message flow 400 for signal processing, according to an example embodiment. A new email message 410 (e.g., user content) for a user is received and a notification 412 is provided to a personalized viewing time (PVT) service 420. In some examples, the PVT service 420 includes an event processor 422 (e.g., implemented by the signal processor 114) that processes events indicated by the notification 412, such as a new message arrival event, a new document creation event, a document view event, a document save event, a meeting creation event, a meeting join event, a meeting end event. The event processor 422 may be an event-based processor or an interrupt-based processor, in various examples. To process the new email message 410, the event processor 422 obtains 414 user-specific weights for the user, where the user-specific weights correspond to parameters for an input 416 of an online neural network model 436. The neural network model 436 generally corresponds to the neural network model 136 but is utilized in an “online” manner using new data as a portion of the input 416 instead of training data. In this example, the new data corresponds to content features of the new email message 410.

The neural network model 436 provides an output 417 to the event processor 422 for verification of a generated signal. In some examples, the generated signal is generated when the new email message 410 is received, when the notification 412 is provided, or at another suitable time after the email message 410 is received. In other examples, the generated signal is generated after the output 417 has been provided by the neural network model 436. As one example, the output 417 is a predicted signal, such as a ViewMessage signal that indicates a duration for reading the email message 410. As another example, the output 417 is a predicted field within a signal, such as the duration for reading the email message 410 (i.e., a sub-portion of the predicted signal instead of the entire signal). The predicted field may include a single value (e.g., 10 seconds, 1 minute), or a range of values (e.g., 10 to 15 seconds, 45 seconds to 1 minute).

In some examples, the event processor 422 compares the output 417 with the generated signal for verification and provides a predicted signal, data structure, or notification as an output 418 when a discrepancy threshold has been met. As one example, the output 418 may be a predicted signal or data structure that is stored in place of a previously generated signal. As another example, the output 418 may be a notification to another computing device (computing device 110, 120, or another suitable device) to cause a generated signal to be updated. In some examples, the output 418 may be an update to the telemetry log 138 or a notification to cause the telemetry log 138 to be updated. Updating the signals or data structures when the discrepancy threshold has been met (e.g., when a data structure is inconsistent with existing data structures) allows the event processor 422 to improve consistency of the signals within the signal data store 132. Accordingly, user-facing features that are performed based on those signals are more likely to be relevant to a user.

The discrepancy threshold may require an exact match between corresponding fields of the output 417 and the generated signal, a partial match between the corresponding fields (e.g., values within 5% or 10%), or a combination of exact and/or partial matches among fields of the output 417 and the generated signal. In other words, some fields may have different discrepancy thresholds. In some examples, the discrepancy threshold is adjustable based on one or more criteria, for example, content features of the email message 410, a type of signal (e.g., ViewMessage, SendMessage, JoinMeeting, CreateDocument, SaveDocument), an identity of the user, or other suitable criteria. In some examples, the discrepancy threshold is selected to be more forgiving (e.g., values within 20%) for a high priority user and more precise (e.g., values within 4%) for a lower priority user. In some examples, a signal that is missing a value for a field is updated to include the missing field or property based on the output 417. For example, a generated signal that is missing an EndTime field may be populated with an EndTime value from the output 417. In other words, a predicted value is generated by the neural network model 436, based on previous values for a particular user, and the predicted value is used to update the generated signal, improving consistency of the generated signals and improving the usefulness of further actions (e.g., analytics or user interface features) that are based on the generated signals. Example actions that may be performed based on the signals include predicting how long a user will need to read and/or reply to an individual email message or even a group of unread email messages, suggesting relevant invitees to a user when scheduling a meeting, or suggesting documents to be uploaded to a website.

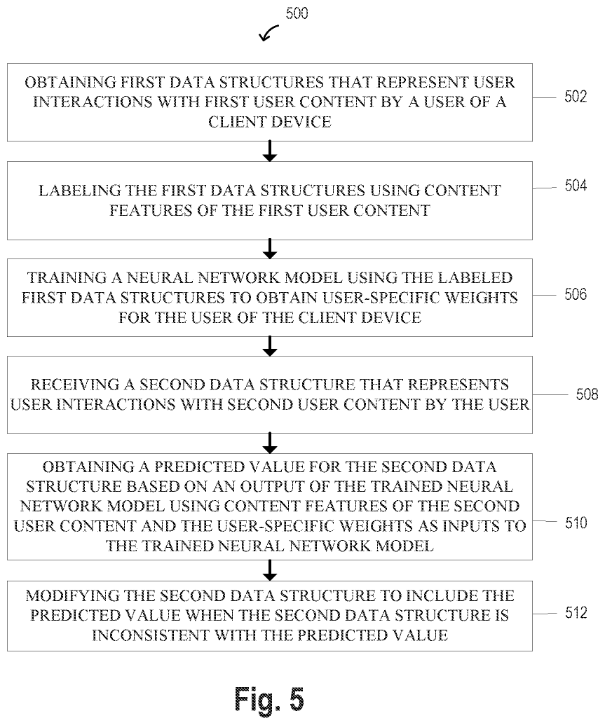

FIG. 5 shows a flowchart of an example method 500 for data structure modification, according to an example embodiment. Technical processes shown in these figures will be performed automatically unless otherwise indicated. In any given embodiment, some steps of a process may be repeated, perhaps with different parameters or data to operate on. Steps in an embodiment may also be performed in a different order than the top-to-bottom order that is laid out in FIG. 5. Steps may be performed serially, in a partially overlapping manner, or fully in parallel. Thus, the order in which steps of method 500 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 5 may be performed by the computing device 110 (e.g., via the signal generator 112, the signal processor 114), the computing device 120 (e.g., via the signal generator 122, the signal processor 124), the data store 130 (e.g., via the neural network model 136), or other suitable computing device.

Method 500 begins with step 502. At step 502, first data structures that represent user interactions with first user content by a user of a client device are obtained. For example, stored signals from the signal data store 132 are obtained by the signal processor 114 or the signal processor 124. In some examples, the signal processor 114 performs a database query for stored signals within the signal data store 132 that have a StartTime field 212 and EndTime field 214 within a particular time range, an ItemID field 218 with a value that links to a particular document, an ItemType field 219 with a value that indicates a particular type, or other suitable database query. In some examples, the database query may be specific to a particular user or group of users.

In some examples, the user interactions with the first user content and the user interactions with the second user content are active interactions. As one example, the user interactions include reading an email and the first user content includes the email. As another example, the user interactions include joining a meeting and the first user content includes a calendar event for the meeting. As yet another example, the user interactions include a file interaction and the first user content is a file that is interacted with by the user. In still other examples, the user interactions include a passive behavior of the user, such as a change in location of the user (e.g., moving from a home location to a work location). In these examples, a passive behavior is passive in the sense that the user does not explicitly provide an input to the client device.

At step 504, the first data structures are labeled using content features of the first user content. The content features may include one or more of portions of the first user content that are viewed by the user (e.g., a subject of an email, text or images within a body of the email, an attachment to the email), user identifiers for other users associated with the user interactions (e.g., a user ID for a sender or recipient of the email, a user ID of an author of a message or document), timestamps associated with the user interactions (e.g., a time when an email or document was received, opened, viewed, closed, etc.), or other content features described above. As one example, the first user content includes an email and the timestamps indicate a start time and end time of viewing the email by the user. In some examples, the first data structures are labeled using fields from signals, such as a Duration field, a StartTime field, an EndTime field, etc. Generally, labeling the first data structures includes associating the label (e.g., the content features or fields from signals) with the first data structures. As one example, the association is performed by creating training data structures that include the labels and the first data structures (or references to the labels and first data structures). As another example, the association is performed by creating training data structures for each of the first data structures. The training data structures may include the labels as first fields and portions of the first data structures (e.g., a subset of fields from the first data structures) as second fields. For example, a training data structure may be a vector having fields for values and references to other data structures, a database entry, or other suitable data structure and may be stored in the training data store 134.

At step 506, a neural network model is trained using the labeled first data structures to obtain user-specific weights for the user of the client device. More specifically, the training data structures from the training data store 134 are provided as inputs to input layer nodes of the neural network model 136, 336, or 436, for example.

At step 508, a second data structure that represents user interactions with second user content by the user is received. In some examples, the event processor 422 receives the notification 412 described above, indicating that the second data structure has been created within the signal data store 132. In other examples, the event processor 422 receives a copy or reference of the second data structure from the substrate signal service (e.g., the signal generator 112, the signal generator 122, the signal processor 114, and the signal processor 124) that generates and/or monitors signals within the signal data store 132.

At step 510, a predicted value for the second data structure is obtained based on an output of the trained neural network model using content features of the second user content and the user-specific weights as inputs to the trained neural network model. In some examples, the event processor 422 obtains 414 user-specific weights for the user from the content data store 433, where the user-specific weights correspond to parameters for the input 416 of the online neural network model 436 as described above. The event processor 422 provides the user-specific weights and content features of the second user content to the online neural network model 436 and receives the output 417 from the online neural network model 436. For example, the event processor 422 may configure the neural network model 436 using the user-specific weights and provide the content features to input nodes of the neural network model 436. In one example, the predicted value corresponds to a ViewMessage signal with an updated EndTime and/or Duration using the output 417 of the neural network model 436. In another example, the predicted value corresponds to a JoinMeeting signal with an updated ItemID field 218 and updated ItemType field 219. In other examples, the predicted value is a timestamp for a CreationTime field 216 for a document.

At step 512, the second data structure is modified to include the predicted value when the second data structure is inconsistent with the predicted value. For example, the event processor 422 may provide the output 418 when the discrepancy threshold has been met, as described above. In one example, the output 418 is a predicted signal or data structure that is stored in place of a previously generated signal. In another example, the output 418 is a notification to another computing device (computing device 110, 120, or another suitable device) to cause the previously generated signal to be updated (e.g., changing a value of a field to the predicted value). In some examples, the second data structure is modified to have changed timestamps (e.g., a changed EndTime field or Duration field). For example, an EndTime field or Duration field of the second data structure is updated to include the predicted value.

In some examples, the method 500 further includes processing a telemetry log for the client device that represents the user interactions with the first user content. The telemetry log may correspond to the telemetry log 138. In these examples, obtaining the predicted value may include cross-verifying the telemetry log with the output of the trained neural network model.

Modification of the second data structure may be based on using any number of content features as labels when training the neural network model 136. As described above, although a high number of labels would normally introduce a high level of complexity and cost in developer time, some of this cost is avoided using the neural network model 136 because a programmer does not need to manually identify content features that influence fields within the signals and create a software routine that explicitly refers to the identified content features. Moreover, the neural network model 136 may also identify non-obvious or counter-intuitive behavior of a user, allowing for previously unavailable recommendations to be made to the user.

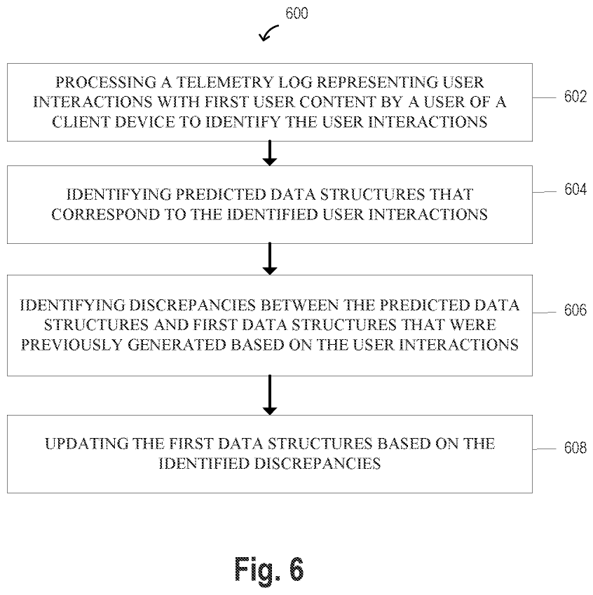

FIG. 6 shows a flowchart of an example method 600 for data structure modification, according to an example embodiment. Technical processes shown in these figures will be performed automatically unless otherwise indicated. In any given embodiment, some steps of a process may be repeated, perhaps with different parameters or data to operate on. Steps in an embodiment may also be performed in a different order than the top-to-bottom order that is laid out in FIG. 6. Steps may be performed serially, in a partially overlapping manner, or fully in parallel. Thus, the order in which steps of method 600 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 6 may be performed by the computing device 110 (e.g., via the signal generator 112, the signal processor 114), the computing device 120 (e.g., via the signal generator 122, the signal processor 124), the data store 130 (e.g., via the neural network model 136), or other suitable computing device.

Method 600 begins with step 602. At step 602, a telemetry log representing first user interactions with first user content by a user of a client device is processed to identify the first user interactions. In some examples, the telemetry log corresponds to the telemetry log 138 and the telemetry processor 128 identifies user interactions based on the telemetry log 138. For example, one or more entries within the telemetry log 138 may indicate that an application for viewing email was activated (e.g., brought into the foreground) and an unread email message was clicked on by a user, then another application was activated and the application for viewing email was moved to the background. Timestamps associated with the entries of the telemetry log 138 may correspond to a duration for a ViewMessage signal. For example, a timestamp of the user's click on the unread email may correspond to a StartTime for a ViewMessage signal, a timestamp of the activation of the other application may correspond to an EndTime for the ViewMessage signal, and a difference between the EndTime and the StartTime may correspond to a Duration of the ViewMessage signal.

At step 604, a predicted data structure that corresponds to the identified first user interactions based on an output of a trained neural network model using content features of the first user content and user-specific weights as inputs to the trained neural network model is generated. Using the above-mentioned example of the ViewMessage signal, the telemetry processor 128 may generate a predicted ViewMessage signal having the StartTime, EndTime, and Duration. In some examples, step 604 includes mapping entries within the telemetry log to fields within the predicted data structure, and populating the fields within the predicted data structure with data based on the mapped entries within the telemetry log. In examples, the telemetry processor 128 maps entries within the telemetry log 138 to fields within a predicted data structure, and populates the fields within the predicted data structure with data based on the mapped entries within the telemetry log 138. For example, an entry within the telemetry log 138 that indicates a text document was opened using a word processing application at a particular time may be used to populate a StartTime field for a signal corresponding to the text document.

At step 606, discrepancies between the predicted data structure and first data structures that were previously generated based on second user interactions of the user of the client device are identified, wherein the second user interactions include the first user interactions. For example, a comparison between the predicted ViewMessage signal and a previously generated ViewMessage signal (e.g., from the signal data store 132) may indicate that the Duration field of the previously generated ViewMessage signal is 3 hours while the Duration field of the predicted ViewMessage signal is 20 seconds. This scenario may result when a user has started reading an unread email message, but then is interrupted, for example, by a phone call or a lunch break.

At step 608, the first data structures are updated based on the identified discrepancies. In one example, the telemetry processor 128 updates the previously generated ViewMessage signal stored within the signal data store 132 to have a Duration field value of 20 seconds instead of 3 hours.

In some examples, step 608 includes receiving an output of a trained neural network model using the predicted data structures and user-specific weights as inputs to the trained neural network model and updating the first data structures based on the output of the trained neural network. The output corresponds to the output 417 from the neural network model 436, for example.

In some examples, the identified discrepancies include an inconsistent field of an existing data structure and updating the first data structures comprises updating the inconsistent field with a predicted value from the predicted data structure. In other examples, the identified discrepancies include a missing data structure and updating the first data structures comprises storing the predicted data structure with the first data structures.

For step 602, the user interactions may include active interactions, such as reading an email and the first user content includes the email, in some examples. In other examples, the user interactions include passive interactions, such as a change in location of the user.

In the method 600, the content features may include one or more of portions of the first user content that are viewed by the user, user identifiers for other users associated with the user interactions, and timestamps associated with the user interactions.

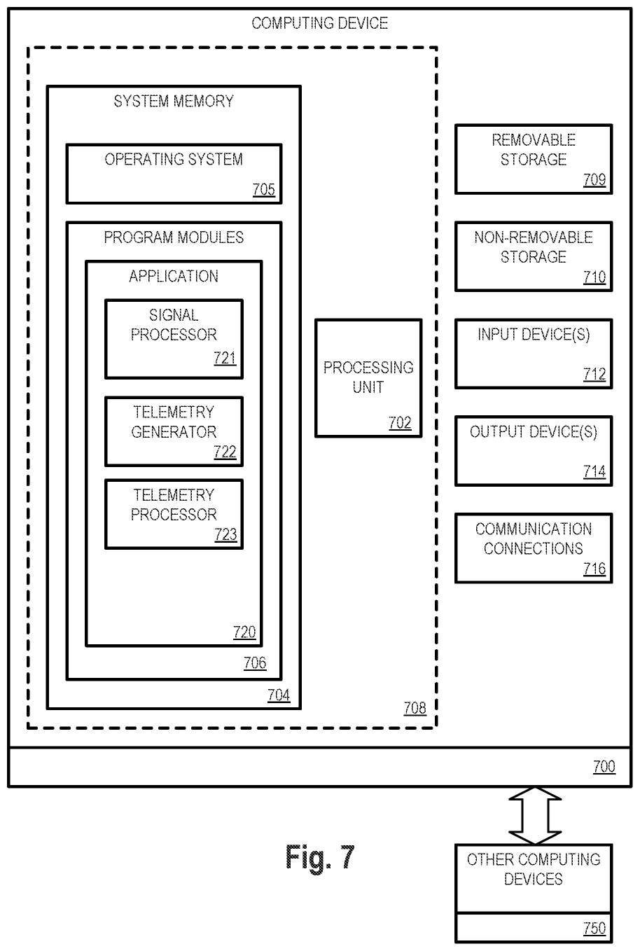

FIG. 7 is a block diagram illustrating physical components (e.g., hardware) of a computing device 700 with which aspects of the disclosure may be practiced. The computing device components described below may have computer executable instructions for implementing a signal processor application 720 on a computing device (e.g., computing device 110), including computer executable instructions for signal processor application 720 that can be executed to implement the methods disclosed herein. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for running signal processor application 720, such as one or more components with regard to FIG. 1, and, in particular, signal processor 721 (e.g., corresponding to signal processor 114 or 124), telemetry generator 722 (e.g., corresponding to telemetry generator 116 or 126), or telemetry processor 723 (e.g., corresponding to telemetry processor 128).

The operating system 705, for example, may be suitable for controlling the operation of the computing device 700. Furthermore, embodiments of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., signal processor application 720) may perform processes including, but not limited to, the aspects, as described herein. Other program modules that may be used in accordance with aspects of the present disclosure, and in particular for caching signals, may include signal processor 721, telemetry generator 722, and/or telemetry processor 723.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

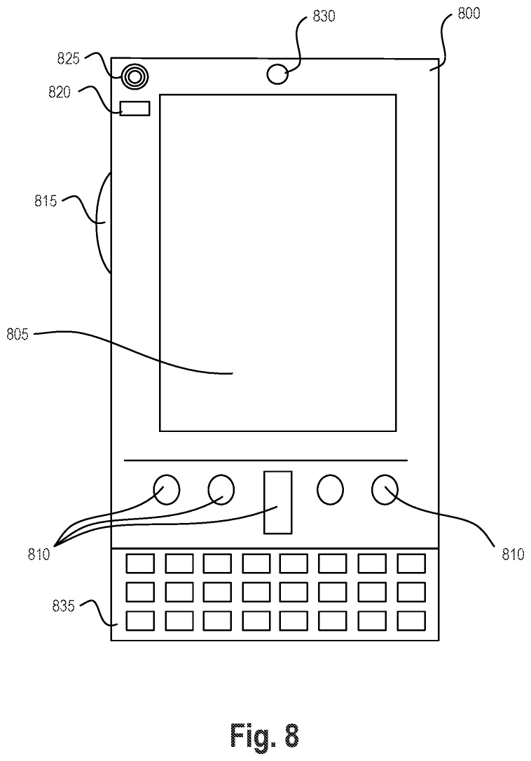

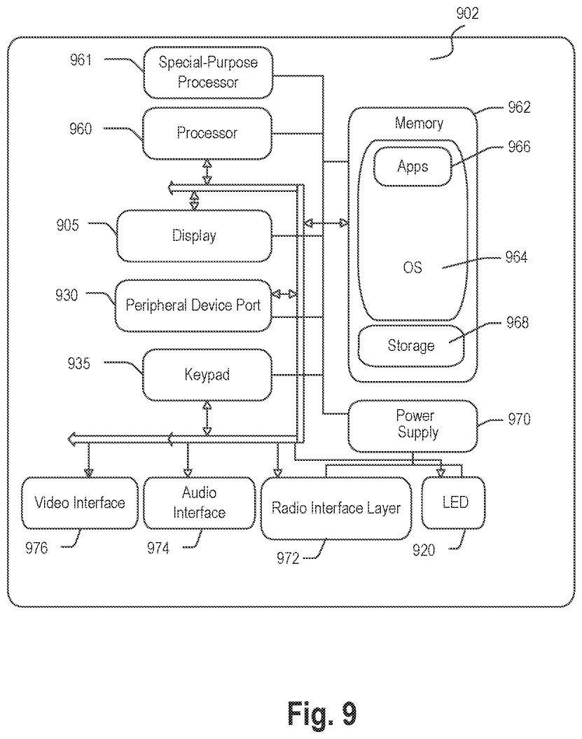

FIGS. 8 and 9 illustrate a mobile computing device 800, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 8, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative aspects, mobile computing device 800 may incorporate more or less input elements. For example, the display 805 may not be a touch screen in some embodiments. In yet another alternative embodiment, the mobile computing device 800 is a portable phone system, such as a cellular phone. The mobile computing device 800 may include a front-facing camera 830. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In some aspects, the mobile computing device 800 incorporates a vibration transducer for providing the user with tactile feedback. In yet another aspect, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 9 is a block diagram illustrating the architecture of one aspect of a mobile computing device. That is, the mobile computing device 900 can incorporate a system (e.g., an architecture) 902 to implement some aspects. In one embodiment, the system 902 is implemented as a “smart phone” capable of running one or more applications (e.g., browser, e-mail, calendaring, contact managers, messaging clients, games, and media clients/players). In some aspects, the system 902 is integrated as a computing device, such as an integrated personal digital assistant (PDA) and wireless phone. The system 902 may include a display 905 (analogous to display 805), such as a touch-screen display or other suitable user interface. The system 902 may also include an optional keypad 935 (analogous to keypad 735) and one or more peripheral device ports 930, such as input and/or output ports for audio, video, control signals, or other suitable signals.

The system 902 may include a processor 960 coupled to memory 962, in some examples. The system 902 may also include a special-purpose processor 961, such as a neural network processor. One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and so forth. The system 902 also includes a non-volatile storage area 968 within the memory 962. The non-volatile storage area 968 may be used to store persistent information that should not be lost if the system 902 is powered down. The application programs 966 may use and store information in the non-volatile storage area 968, such as email or other messages used by an email application, and the like. A synchronization application (not shown) also resides on the system 902 and is programmed to interact with a corresponding synchronization application resident on a host computer to keep the information stored in the non-volatile storage area 968 synchronized with corresponding information stored at the host computer.

The system 902 has a power supply 970, which may be implemented as one or more batteries. The power supply 970 may further include an external power source, such as an AC adapter or a powered docking cradle that supplements or recharges the batteries.

The system 902 may also include a radio interface layer 972 that performs the function of transmitting and receiving radio frequency communications. The radio interface layer 972 facilitates wireless connectivity between the system 902 and the “outside world,” via a communications carrier or service provider. Transmissions to and from the radio interface layer 972 are conducted under control of the operating system 964. In other words, communications received by the radio interface layer 972 may be disseminated to the application programs 966 via the operating system 864, and vice versa.

The visual indicator 920 may be used to provide visual notifications, and/or an audio interface 974 may be used for producing audible notifications via an audio transducer 825 (e.g., audio transducer 825 illustrated in FIG. 8). In the illustrated embodiment, the visual indicator 920 is a light emitting diode (LED) and the audio transducer 825 may be a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 825, the audio interface 974 may also be coupled to a microphone to receive audible input, such as to facilitate a telephone conversation. In accordance with embodiments of the present disclosure, the microphone may also serve as an audio sensor to facilitate control of notifications, as will be described below. The system 902 may further include a video interface 976 that enables an operation of peripheral device port 930 (e.g., for an on-board camera) to record still images, video stream, and the like.

A mobile computing device 900 implementing the system 902 may have additional features or functionality. For example, the mobile computing device 900 may also include additional data storage devices (removable and/or non-removable) such as, magnetic disks, optical disks, or tape. Such additional storage is illustrated in FIG. 9 by the non-volatile storage area 968.

Data/information generated or captured by the mobile computing device 900 and stored via the system 902 may be stored locally on the mobile computing device 900, as described above, or the data may be stored on any number of storage media that may be accessed by the device via the radio interface layer 972 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio interface layer 972 or via a distributed computing network. Similarly, such data/information may be readily transferred between computing devices for storage and use according to well-known data/information transfer and storage means, including electronic mail and collaborative data/information sharing systems.

As should be appreciated, FIGS. 8 and 9 are described for purposes of illustrating the present methods and systems and is not intended to limit the disclosure to a particular sequence of steps or a particular combination of hardware or software components.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for data structure modification, the method comprising:
obtaining first data structures that represent user interactions with first user content by a user of a client device;
labeling the first data structures using content features of the first user content;
training a neural network model using the labeled first data structures to obtain user-specific weights for the user of the client device;
receiving a second data structure that represents user interactions with second user content by the user;
obtaining a predicted value for the second data structure based on an output of the trained neural network model using content features of the second user content and the user-specific weights as inputs to the trained neural network model; and
modifying the second data structure to include the predicted value when the second data structure is inconsistent with the predicted value.

2. The method of claim 1, wherein the user interactions with the first user content and the user interactions with the second user content are active interactions.

3. The method of claim 1, wherein labeling the first data structures comprises labeling the first data structures using an identifier of an author of the first user content.

4. The method of claim 1, wherein labeling the first data structures comprises labeling the first data structures using a timestamp indicating when the first user content was viewed.

5. The method of claim 1, wherein labeling the first data structures comprises, for each of the first data structures, creating a training data structure that includes one or more labels from the first user content as first fields and portions of a corresponding first data structure as second fields.

6. The method of claim 1, wherein the user interactions with the first user content include a passive behavior of the user.

7. The method of claim 1, wherein the content features of the first user content include one or more of portions of the first user content that are viewed by the user, user identifiers for other users associated with the user interactions, and timestamps associated with the user interactions.

8. The method of claim 7, wherein the second data structure is modified to have changed timestamps.

9. The method of claim 1, wherein obtaining the predicted value comprises:
configuring the trained neural network model using the user-specific weights; and
providing the content features to input nodes of the trained neural network model.

10. The method of claim 1, wherein modifying the second data structure comprises updating a field of the second data structure to include the predicted value.

11. The method of claim 1, wherein receiving the second data structure comprises receiving the second data structure from a signal service that generates the second data structure based on the user interactions with the second user content by the user.

12. The method of claim 1, wherein the method further comprises processing a telemetry log for the client device that represents the user interactions with the first user content; and
wherein obtaining the predicted value comprises cross-verifying the telemetry log with the output of the trained neural network model.

13. A method for data structure modification, the method comprising:
processing a telemetry log representing first user interactions with first user content by a user of a client device to identify the first user interactions;
generating a predicted data structure that corresponds to the identified first user interactions based on an output of a trained neural network model using content features of the first user content and user-specific weights as inputs to the trained neural network model, including mapping entries within the telemetry log to fields within the predicted data structure, and populating the fields within the predicted data structure with data based on the mapped entries within the telemetry log;
identifying discrepancies between the predicted data structure and first data structures that were previously generated based on second user interactions of the user of the client device, wherein the second user interactions include the first user interactions; and
updating the first data structures based on the identified discrepancies.

14. The method of claim 13, wherein:
the identified discrepancies include an inconsistent field of an existing data structure; and
updating the first data structures comprises updating the inconsistent field with a predicted value from the predicted data structure.

15. The method of claim 13, wherein:
the identified discrepancies include a missing data structure; and
updating the first data structures comprises storing the predicted data structure with the first data structures.

16. The method of claim 13, wherein:
the first user interactions include reading an email by the user;
the first user content includes the email; and
the predicted data structure comprises a plurality of fields including a duration field that indicates a time period for reading the email.

17. The method of claim 13, wherein the content features include one or more of portions of the first user content that are viewed by the user, user identifiers for other users associated with the user interactions, and timestamps associated with the user interactions.

18. A system for processing data structures that represent user interactions, the system comprising:
a signal processor configured to process received data structures;
wherein the signal processor is configured to:
obtain first data structures that represent user interactions with first user content by a user of a client device;
label the first data structures using content features of the first user content;
train a neural network model using the labeled first data structures to obtain user-specific weights for the user of the client device;
receive a second data structure that represents user interactions with second user content by the user;
obtain a predicted value for the second data structure based on an output of the trained neural network model using content features of the second user content and the user-specific weights as inputs to the trained neural network model; and
modify the second data structure to include the predicted value when the second data structure is inconsistent with the predicted value.

19. The system of claim 18, wherein the content features include one or more of portions of the first user content that are viewed by the user, user identifiers for other users associated with the user interactions, and timestamps associated with the user interactions.

20. The system of claim 18, wherein the signal processor is further configured to process a telemetry log for the client device that represents the user interactions with the first user content and cross-verify the telemetry log with the output of the trained neural network model.
